(19) United States
(12) Patent Application Publication
(10) Pub. No.: US 2019/0196019 A1
(43) Pub. Date: Jun. 27, 2019

(54) METHOD AND DEVICE FOR DETERMINING POSITION OF A TARGET

(71) Applicant: SINGAPORE UNIVERSITY OF TECHNOLOGY AND DESIGN, Singapore (SG)

(72) Inventors: Anusha Indrajith WITHANAGE DON, Singapore (SG); Suranga Chandima NANAYAKKARA, Singapore (SG); Shanaka Ransiri PULUKKUTTI ARACHCHIGE DON, Singapore (SG)

(21) Appl. No.: 16/329,156

(22) PCT Filed: Aug. 22, 2017
(86) PCT No.: PCT/SG2017/050412

§ 371 Date: Feb. 27, 2019

(30) Foreign Application Priority Data
Aug. 31, 2016 (SG) 10201607239Q

(51) Int. Cl. G01S 17/66; G01S 17/48; G01S 7/48; G06K 9/00; G06F 3/01

(52) U.S. Cl. CPC G01S 17/66; G01S 17/48; G06F 3/017; G06K 9/00335; G06K 9/00624; G01S 7/4802

(57) ABSTRACT

Method and device for determining a position of a target is disclosed herein. In a described embodiment, the method includes sequentially directing each of a plurality of lighting patterns at the target, each lighting pattern comprising a plurality of illuminations from respective ones of a plurality of emitters, receiving, at a plurality of sensors, reflected illumination of each lighting pattern as reflected from the target; and determining the position of the target using the reflected illuminations of the lighting patterns and a first classifier previously trained to associate the reflected illuminations to a position of the target. In the method, each lighting pattern differs from other lighting patterns by at least an intensity of one of the illuminations; and the intensity of the illumination from at least one emitter is variable between more than two levels. A method of training a classifier for use in the method is also disclosed.

### FIELD AND BACKGROUND

The invention relates to a method and device for determining positions of a target, more particularly but not exclusively, for determining gestures of a hand.

Capabilities of wearable smart devices are growing and rich interaction techniques for such capable systems are in high demand. A particular technique uses camera-based gesture recognition. Specifically, computer vision technologies such as 2D cameras, markers and commercial depth cameras have been proposed to track gestures in real time. For example, it has been proposed to use a depth camera attached to a shoulder of a user to identify various gestures or surfaces for interaction in air. In another system, a similar depth camera tracking system is used to provide around-the-device interaction to investigate free-space interactions for multi-scale navigation with mobile devices. However, such computer vision based approaches require high computational processing power and high energy for operation, which makes these technologies less desirable for resource constrained application domains.

Another known technique is magnetic field based gesture sensing which has been used to extend the interaction space around mobile devices. In such a technique, external permanent magnets are used to extend the interaction space around a mobile device. The mobile device includes inbuilt magnetometers to detect the magnetic field changes around the device and these changes used as inputs to a sensing system. It has also been proposed to use a magnet on a user's finger for gestural input and unpowered devices for interaction. However, the magnetic sensing approach requires instrumenting the user, generally requiring the user to wear a magnet on the fingertip.

In a further technique, the mobile device may be embedded with a sound senor to classify various sounds. It allows the user to perform different interactions by interacting with an object using the fingernail, knuckle, tip, etc. It has also been proposed to uses the human body for acoustic transmission, and in a specific implementation, a sensor is embedded in an armband to identify and localise vibrations caused by taps on the body as a form of input.

Infrared (IR) is another technique that has been used to extend the interaction space with mobile devices. In a known example, arrays of infrared sensors has been proposed to be attached on two sides of a mobile device to provide multi-“touch” interaction when placed on a flat surface. In another example, infrared beams reflected from the back of a user's hand are used to extend interactions with a smart wristwatch. In a further example, infrared proximity sensors located on a wrist worn device combined with hidden Markov models are used to recognise gestures for interaction with other devices. However, since these projects use linear sampling with IR sensors, a high density of emitters and sensors are necessary to track gestures from a relatively small space making them power in-efficient.

A 3D gesture sensor has also been proposed that uses a three pixel infrared time of flight module combined with a RGB camera. However, measuring time of flight requires extremely high sampling frequencies, data conditioning and processing, which is usually not available in wearable devices. Non-linear spatial sampling (NSS) for gesture recognition has also been proposed where a shallow depth gesture recognition system was introduced using comparable small number of sensors and emitters for recognizing finger gestures. However, the gesture recognition technique is highly vulnerable to noise and the sensing range is relatively much smaller (˜15 cm).

It is desirable to provide a method and device for determining positions of a target which addresses at least one of the drawbacks of the prior art and/or to provide the public with a useful choice.

### SUMMARY

In a first aspect, there is provided a method for determining a position of a target comprising: sequentially directing each of a plurality of lighting patterns at the target, each lighting pattern comprising a plurality of illuminations from respective ones of a plurality of emitters, receiving, at a plurality of sensors, reflected illumination of each lighting pattern as reflected from the target; and determining the position of the target using the reflected illuminations of the lighting patterns and a first classifier previously trained to associate the reflected illuminations to a position of the target; wherein each lighting pattern differs from other lighting patterns by at least an intensity of one of the illuminations; and wherein the intensity of the illumination from at least one emitter is variable between more than two levels.

By varying the intensities between more levels, the described embodiment has a greater variety of lighting patterns directed at the target. In turn, there is a greater variety of reflected illuminations received at the sensors, and this can help make the classifier (trained using the reflected illuminations) more accurate. The range of detection and immunity of noise can hence be increased.

In a second aspect, there is provided a method for training a classifier for determining a position of a target, the method comprising:

(i) placing the target at a first known position;

(ii) sequentially directing each of a plurality of lighting patterns at the target, each lighting pattern comprising a plurality of illuminations from respective ones of a plurality of emitters, wherein each lighting pattern differs from other lighting patterns by at least an intensity of one of the illuminations and wherein the intensity of the illumination from at least one emitter is variable between more than two levels;

(iii) receiving, at a plurality of sensors, reflected illumination of each lighting pattern as reflected from the target;

(iv) moving the target to a subsequent known position;

(v) repeating (ii)-(iv) for a predetermined number of subsequent known positions; and

(vi) training the classifier to associate the reflected illuminations to positions of the target using the reflected illuminations and the known positions.

In either method, at least two lighting patterns may differ by a direction of one of the illuminations. Further, receiving, at a plurality of sensors, reflected illumination of each lighting pattern as reflected from the target may comprise receiving at a first sensor reflected illumination of a first lighting pattern; changing a direction of the first sensor; and receiving at the first sensor reflected illumination of a second lighting pattern.

Either method may also include, for each lighting pattern, a direction of each illumination is at a non-zero angle with respect to a direction of at least one other illumination. In one embodiment, the emitters may be arranged in a non-linear configuration, such as long a curve. In an alternative embodiment, the emitters may be arranged at points lying in a non-linear configuration on a flat surface.

Also, it is envisaged that the emitters may be arranged in a linear configuration and are cooperatively configured to direct the illuminations in particular directions to form each lighting pattern.

Preferably, sequentially directing each of a plurality of lighting patterns at the target may comprise providing idle periods of time between consecutive lighting patterns, wherein during each idle period of time, all the emitters are turned off. The position of the target may be determined using digital output from the plurality of sensors, the digital output being indicative of the reflected illuminations.

In a third aspect, there is provided a method for recognizing a gesture formed by moving a target through a plurality of positions, the method comprising: determining each position of the target by a method of any one of the preceding aspects and a sequence of the positions; and recognizing the gesture using the determined sequence of the positions and a second classifier associating sequences of positions of the target to respective gestures.

In one embodiment, there may be two emitters and six sensors, although other configurations are envisaged.

In a fourth aspect, there is provided a device for determining a position of a target comprising: a plurality of emitters cooperatively configured to sequentially direct each of a plurality of lighting patterns at the target, each lighting pattern comprising a plurality of illuminations from respective ones of the plurality of emitters; a plurality of sensors configured to receive reflected illumination of each lighting pattern as reflected from the target; a processor configured to determine the position of the target using the reflected illuminations of the lighting patterns and a first classifier previously trained to associate the reflected illuminations to a position of the target; wherein each lighting pattern differs from other lighting patterns by at least an intensity of one of the illuminations; and wherein at least one emitter is configured to provide an illumination with an intensity variable between more than two levels.

The device may further comprise a modulator arranged to receive a transmission signal generated by the processor, and to modulate the transmission signal with a carrier signal to generate a modulated signal.

Preferably, the device may further comprise a power level controller arranged to receive the modulated signal and to generate a control signal for operating each emitter at eight different intensity levels for the corresponding lighting pattern. In a specific example, frequency of the carrier signal may be 57.6 kHz.

The device may also comprise a receiver arranged to receive the reflected illumination of each lighting pattern from the plurality of sensors and for converting the received reflected illumination into a digital signal, and the processor may be arranged to determine the position of the target based on the digital signal.

Advantageously, the device may further comprise a second classifier previously trained to associate detected positions of the target with a distinct gesture. The device may also further comprise an interaction module for interacting with a virtual reality device using the distinct gesture.

It is envisaged that the device may comprise one of a virtual reality device, a mobile device or a device for public use. In a specific example, another aspect of the invention may include a wearable virtual reality headset comprising the device as discussed above.

It should be appreciated that features relevant to one aspect may also be relevant to the other aspects.

### BRIEF DESCRIPTION OF THE DRAWINGS

An exemplary embodiment will now be described with reference to the accompanying drawings, in which:

FIG. 1 is a functional block diagram of a gesture recognition device comprising a number of IR emitters and IR sensors according to an embodiment;

FIGS. 2a and 2b show how the IR emitters and IR sensors of the gesture recognition device of FIG. 1 may achieve spatial displacements;

FIG. 2c is an enlarged view of portion AA of FIG. 2a to illustrate an emitter-sensor pair;

FIG. 3 illustrates how an emitter-sensor pair of the gesture recognition device of FIG. 1 emits an IR ray at a target and detects a reflected IR ray;

FIGS. 4, 5 and 6 are simplified representations of different locations of the emitter-sensor pair of FIG. 3 relative to the target;

FIGS. 7, 8 and 9 illustrate respective volumetric illuminations corresponding to the emitter-sensor pair arrangements of FIGS. 4, 5 and 6 at various power outputs of the IR emitter;

FIG. 10 illustrates a setup for training a classifier of the gesture recognition device of FIG. 1;

FIGS. 11 and 12 illustrate eight distinct gestures used by a user for recognition by the gesture recognition device of FIG. 1 and for interacting with a virtual reality application;

FIG. 13 is a flowchart illustrating a method performed by the gesture recognition device of FIG. 1; and

FIGS. 14a to 14l show steps to refine training data based on the setup of FIG. 10.

### DETAILED DESCRIPTION OF PREFERRED EMBODIMENT

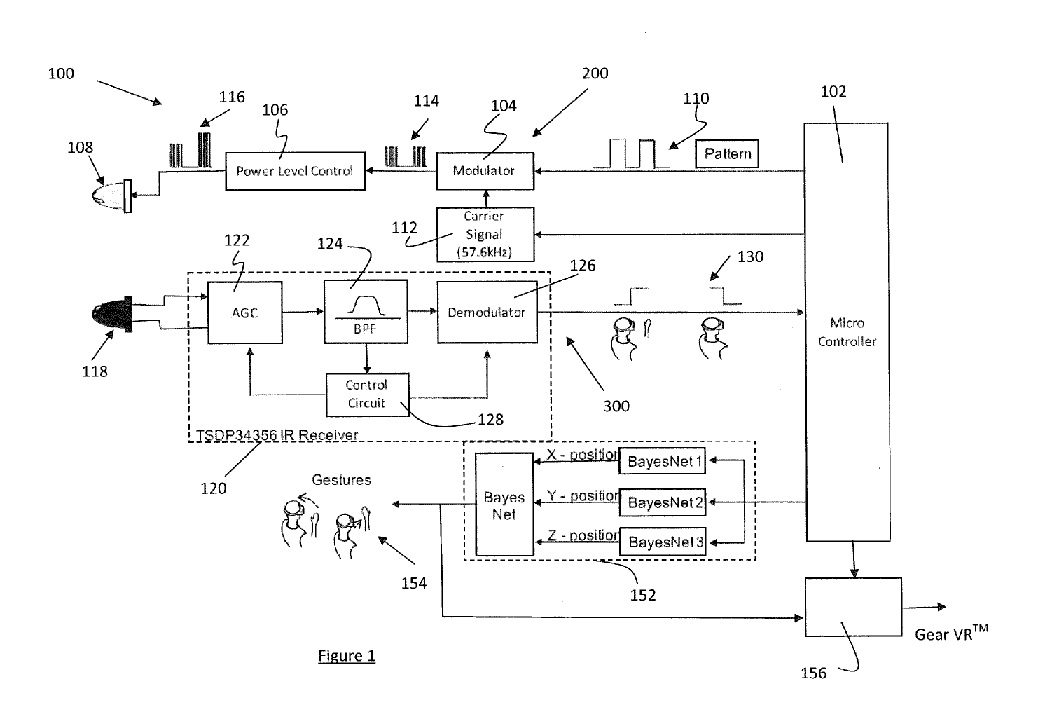

FIG. 1 a functional block diagram of a gesture recognition device 100 according to an embodiment. The gesture recognition device 100 includes a microcontroller 102 such as Nordic nRF51822 (16 MHz, 3.3V) System on a Chip (SoC) microprocessor, which has built-in Bluetooth Low Energy (BLE) and this enables the gesture recognition device 100 to communicate with devices such as smartphones. In this way, the gesture recognition device 100 may also be configured as an extension to wearable devices such as Samsung™ Gear VR™.

The gesture recognition device 100 further includes an IR emission channel 200 and an IR sensing channel 300. In this exemplary embodiment, in the IR emission channel 200, the gesture recognition device 100 includes a modulator 104, a power level controller 106 and a plurality of IR emitters 108 (although only one is shown in FIG. 1). The microcontroller 102 is arranged to generate a transmission signal 110 and the modulator 104 is arranged to modulate the transmission signal 110 with a carrier signal 112 of 57.6 KHz to generate a modulated signal 114 which is relatively immune to background noise.

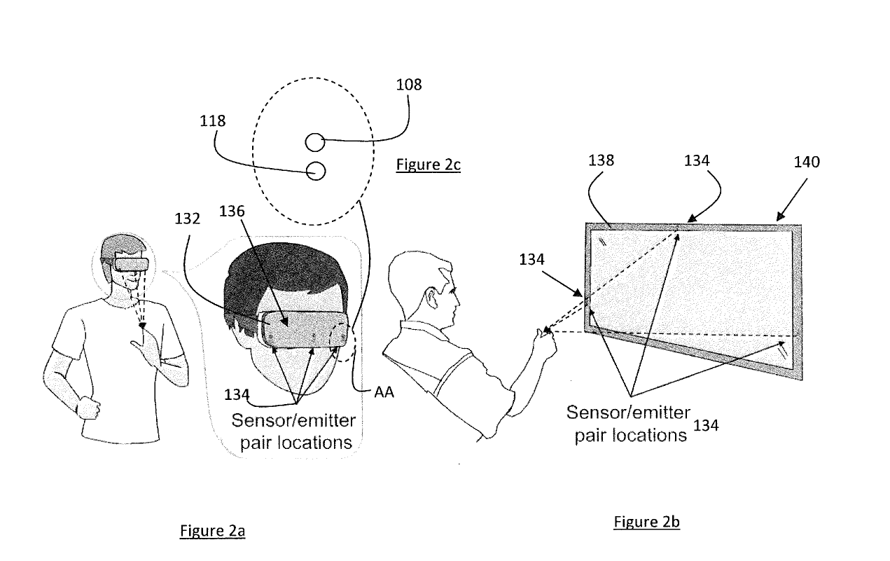

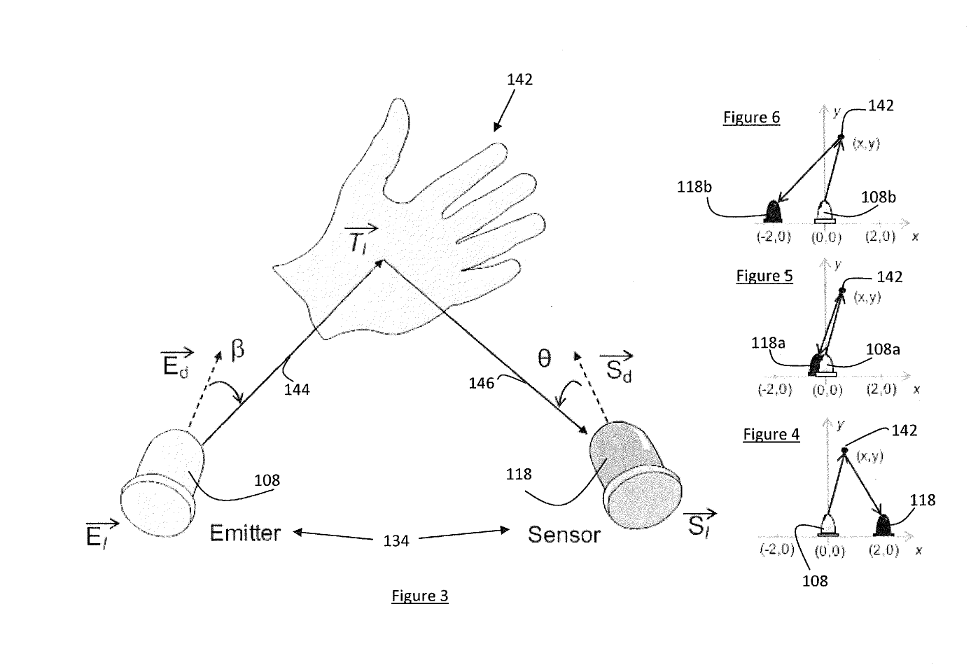

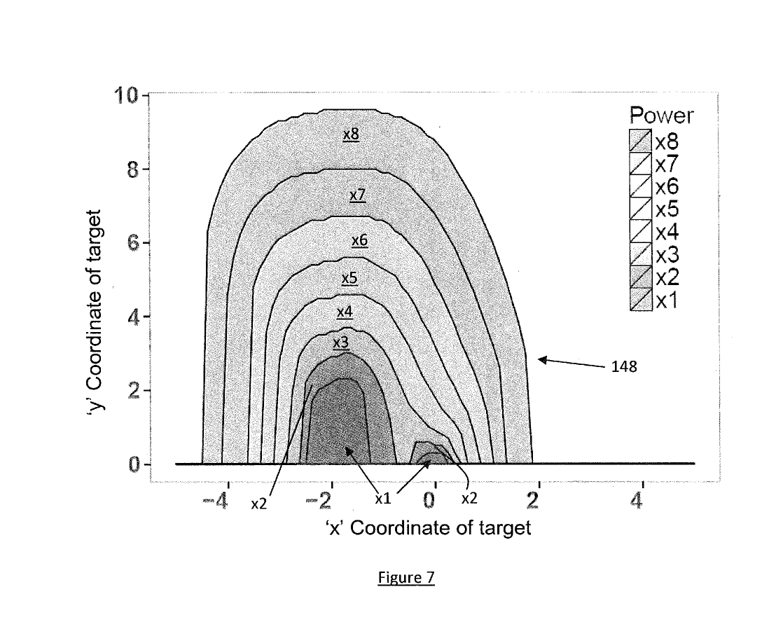

The power level controller 106 then processes the modulated signal 114 to achieve selective volumetric illumination (SVI) by generating a control signal 116 to control the power supplied to the IR emitters 108. In this embodiment, each IR emitter 108 may be operated at eight different intensity/power levels by the control signal 116 achieving a total of sixteen different SVI patterns with each IR emitter 108 arranged to generate respective lighting patterns on a target such as a hand of a user (see FIGS. 2a and 3).

The IR sensing channel 300 includes a plurality of IR sensors 118 (again, only one is shown in FIG. 1) for detecting reflected light from the target and an IR receiver 120 for processing the detected light from the IR sensors 118. The IR receiver 120 includes an automatic gain controller (AGC) 122, band-pass filter (BPF) 124, a demodulator 126 and a control circuit 128 for controlling the AGC 122 and the BPF 124 in order to detect the reflected light even in a noisy environment. From the detected signal, the IR receiver 120 generates a digital signal 130 to represent a location of the target which is fed to the microcontroller 102 using its General Purpose Input Out-put (GPIO) pins. It should be appreciated that since there are multiple emitters and sensors, the digital signal 130 would represent detected light levels from various sensors 118 with respect to each lighting pattern from the emitters 108 and not just from one sensor.

This self-contained sensing channel 300 eliminates the need for an amplifier circuit, which may be needed if a generic photo diode is used. Furthermore, it enables the IR emitters 108 to be operated at very low power levels spanning from 1.05 mW to 18.3 mW. Each SVI pattern from each IR emitter 108 is kept on for 210 μs and then kept off for 420 μs. After sixteen such SVI patterns, there is an off time of 10 ms making the average power consumption of the gesture recognition device 100 with six IR sensors 118 and two IR emitters 108 (excluding the microcontroller 102) about 8 mW.

The SVI patterns 116 are intended to implement a non-linear spatial sampling scheme. Specifically, the IR emitters 108 cooperative to sequentially direct each of the lighting patterns at the target, with each lighting pattern comprising a plurality of lighting illuminations having varying power levels. The plurality of lighting illuminations are arranged to illuminate selected volumetric regions of the interested scene and the sensing channel 300 is arranged to collect a non-linear sample of the reflected energy from the target. Compared to traditional camera based approach or linear sampling approach, SVI is able to make use of a lower number of sensors and less illumination power for determining positions of a target. Due to this volumetric modulation of the sensing environment, required amount of information needed for sensing a gesture is reduced. This further reduces the required power and processing capability.

The IR emitters 108 and IR sensors 118 are spaced from each other and due to relative spatial displacements (linear or angular) between the IR sensors 118 and the IR emitters 108 along with temporal volumetric modulation of emitter irradiance, captured signal by the IR sensors 118 carries spatial information of energy reflecting targets in the scene. Therefore, spatial arrangement of the IR sensors 118 and the IR emitters 108 is an important factor in determining the modulated spatial illumination pattern and the quality of the captured or detected signal. In this embodiment, the gesture recognition device 100 has at least two IR emitters 108 operatively working with one or more sensors 118. Of course, accuracy and number of recognizable gestures increase with more IR sensors 118 and emitters 108. For smaller mobile devices, a tradeoff is required for the accuracy and the number of desirable gestures at the design stage.

Spatial configurations of the IR emitters 108 and the power at which the IR emitters 108 radiate determine the effective illumination of a scene. FIGS. 2a and 2b illustrate two examples of achieving spatial displacements from the IR emitters 108. In FIG. 2a, the gesture recognition device 100 is configured as an extension to a Gear VR™ headset 132, and includes three IR emitter-sensor pairs 134 mounted across an outward facing surface 136 of an optical lens of the Gear VR™ headset 132, with each emitter-sensor pair 134 comprising one IR emitter 108 and one IR sensor 118. FIG. 2c is an enlarged view of portion AA to show the IR emitter 108 and IR sensor 118 more clearly.

Spatial displacement may either be a linear displacement or an angular displacement. The outward facing surface 136 is generally flat but slightly curved at the edges (in a convex manner), and since two of the emitter-sensor pairs 134 are mounted at points near the edges of the outward facing surface 136, the example of FIG. 2a shows a combination of linear and angular displacement leveraging on the curved surface of the Gear VR™ headset 132. In other words, the emitters 108 are arranged in a non-linear configuration and in this example, along a curve defined by the outward facing surface 136.

In the alternative, in FIG. 2b, three emitter-sensor pairs 134 are mounted at various locations of a perimeter edge 138 of a large flat display 140 (such as a television) and illustrates a two dimensional linear displacement of the sensors 118 and emitters 108. It should be appreciated that in the arrangement of FIG. 2b, the sensor pairs 134 are arranged in a linear plane, faces and in front of the user and the user's hand. In contrast, in the case of the arrangement of FIG. 2a, the emitter-sensor pairs 134 are between the user's head and the hands.

As it can be appreciated, SVI selectively illuminates different areas of a scene with variable power IR radiation (emitted by the IR emitters 108) and capturing activity (i.e. reflected illumination) using non-focused IR sensors 118. Irradiance pattern of a given IR emitter depends on the power emission and optical gain of the emitter. Accordingly, different sensors will create a unique three-dimensional illumination region on the space it is exerting the energy. Similarly, IR sensors also have their own sensitivity region, which is defined by the sensitivity of the sensor, optical gain and the signal to noise ratio in post signal processing. Accordingly, SVI of this embodiment requires controlling the emission power via the power level controller 106 as the primary mode of controlling the volumetric illumination. Further, directionality of the IR emitters 108 and/or sensors 118 are also controlled as a secondary mode of control. Specifically, the directionality of the IR emitters/sensors 108,118 may be controlled by changing an actual orientation of the physical location or mounting of the emitters/sensors 108,118.

The use of SVI in the present embodiment would be further explained with reference to FIG. 3 which illustrates an emitter-sensor pair 134 for sensing gestures of a hand 142. For ease of explanation, the IR sensor 118 is illustrated to the right of the IR emitter 108. Of course, it should be appreciated that the emitter-sensor pair 134 may be arranged with the emitter and sensor one on top of the other, similar to the arrangement of FIG. 2c.

In FIG. 3, the IR emitter 108 is disposed at location Eₗ and arranged to emit an IR ray 144 in a direction represented by unit vector E_{d} at the hand 142 which is the target at location Tₗ. The IR sensor 118 is disposed at location S, and is arranged to detect in a direction represented by unit vector S_{d} to detect a reflected ray 146. β and θ represent respectively incident and reflected angles of the emitted and reflected rays with reference to the corresponding vector directions E_{d} and S_{d}. It can be appreciated that in the exemplary illustration of FIG. 3, the incident and reflected rays, β and θ, are non-zero.

Let's take I(θ) and G(β) to be optical characteristic-radiation pattern of sensor and emitter gain profiles respectively and an emission power of the emitter 108 is represented as Pᵢ where (i=0, 1, 2, . . . , n), received intensity, f(Tₗ), at the sensor 118 can be expressed as,

$$f ( {\vec{T}}_{i} ) = \frac{I ( {θ}_{( {\vec{T}}_{i} )} ) G ( {β}_{( {\vec{T}}_{i} )} ) {P}_{i}}{16 {π}^{2} ( {\vert {\vec{T}}_{i} - {\vec{E}}_{i} \vert}^{2} {\vert {\vec{S}}_{i} - {\vec{T}}_{i} \vert}^{2} )} \\ where \\ {θ}_{( {\vec{T}}_{i} )} = {cos}^{- 1} \frac{( {\vec{T}}_{i} - {\vec{E}}_{f} ) \cdot {\vec{E}}_{d}}{{\vec{T}}_{i} - {\vec{E}}_{d}} and \\ {β}_{( {\vec{T}}_{i} )} = {cos}^{- 1} \frac{( {\vec{T}}_{i} - {\vec{S}}_{i} ) \cdot {\vec{S}}_{i}}{{\vec{T}}_{i} - {\vec{S}}_{i}} \qquad ( 1 )$$

In order to demonstrate the SVI feature further, let's consider the optical power distribution in a plane where the emitter 108 and the receiver 118 is configured at half power angle ±30° for locating a target. In this case I_{d}(θ), sensor gain profile, and Gₛ(β), emitter gain profile, can be approximately estimated to be,

$${I}_{d} ( θ ) = {G}_{s} ( β ) = \frac{1}{1 + {\vert \frac{θ}{30} \vert}^{3}}$$

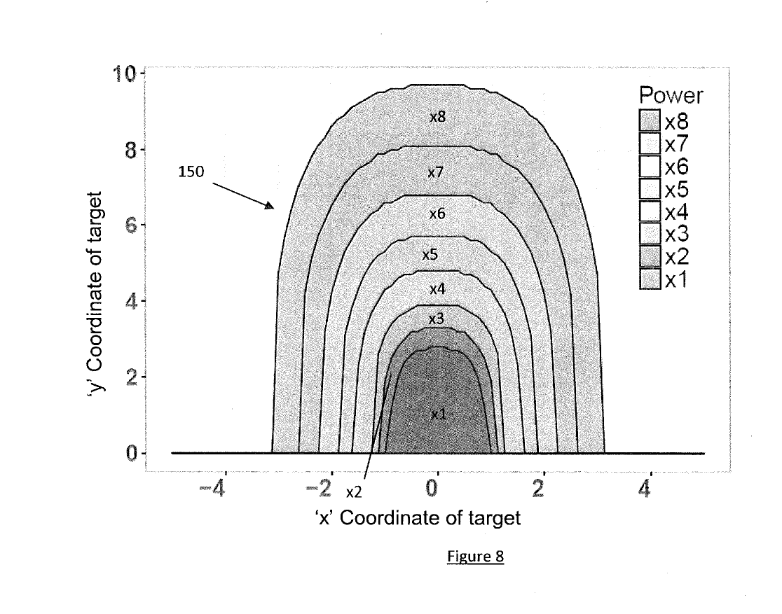

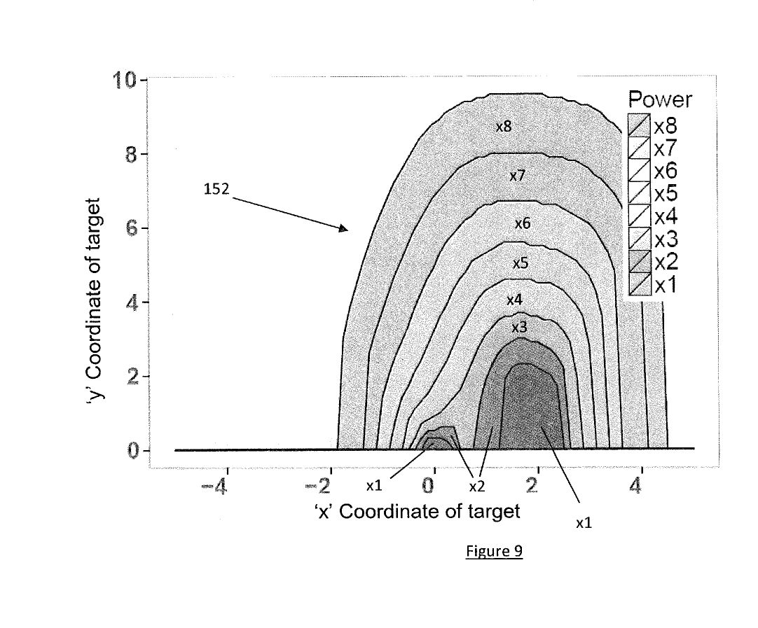

FIG. 4 is a simplified representation of the emitter-sensor pair 134 arrangement of FIG. 3 in X-Y coordinates to illustrate the position of the hand 142 in relation to the emitter 108 and sensor 118. FIG. 7 shows the corresponding first volumetric illumination 148 experienced by the sensor 118 in response to a lighting pattern having regions of illuminations emitted by the emitter 108 with different power outputs x1 to x8 and as reflected by the target at various X-Y coordinates.

is FIG. 5 illustrates locations for a second emitter-sensor pair 134 and the pair 134 is denoted as a second emitter 108a and a second sensor 118a. The location of the second emitter 108a is in the same location as the emitter 108 of the emitter-sensor pair 134 of FIG. 4 but not the location of the second sensor 118a. Thus, the combination of the second emitter-sensor pair 134 would generate a unique volumetric illumination 150 as shown in FIG. 8 in view of a second lighting pattern and corresponding plurality of illuminations emitted by the second emitter 108a at different power levels and as sensed by second sensor 118a in view of the reflections caused by the target 142. FIG. 6 illustrates further locations for a third emitter-sensor pair 134 and the pair 134 is denoted as a third emitter 108b and a third sensor 118b. The location of the third emitter 108b is the same as the emitters 108,108a of FIGS. 4 and 5, but the location of the third sensor 118a is different from the sensor locations of FIGS. 4 and 5. The combination of the third emitter 108b and third sensor 118b would generate a further unique volumetric illumination as shown in FIG. 9 in view of a third lighting pattern and corresponding plurality of illuminations emitted by the third emitter 108a at different power levels and as sensed by the third sensor 118b in view of the reflections caused by the target 142.

As illustrated in FIGS. 4 to 6 and their corresponding volumetric (3D) illuminations, different locations of the emitter and sensor of an emitter-sensor pair 134 would generate different reflected volumetric illuminations depending on the location of the target/hand 142 and thus, this can be used to detect the movement of the hand. It should also be appreciated that the lighting pattern emitted by the emitters 108,108a,108b of each emitter-pair 134 differs from the other lighting patterns by at least one intensity of one of the illuminations and also, the intensity of the illumination generated by each emitter 108,108a,108b may vary by more than two levels. Indeed, FIGS. 4 to 6 and their corresponding volumetric illuminations are for given configurations of the emitter-sensor pair and the configurations and locations of the emitter-sensor pair may change depending on application (and available space).

FIGS. 4 to 6 illustrate the target/hand 142 in the same position and the corresponding volumetric illuminations when the sensor 118,118a,118b is located at different positions relative to the emitter 108,108a,108b. It would be appreciated that if the emitter 108,108a,108b has a different position in relation to the sensor 118,118a,118b, different volumetric illuminations would also be formed. Likewise, in the case of a hand gesture which can be regarded as being formed by the hand adopting a sequence of different positions, each of these positions would create a corresponding volumetric illumination and thus, based on the corresponding volumetric illuminations, it would be possible to know the hand's position.

With the description of the SVI, it would be appreciated that the detected volumetric illuminations would be provided to the micro-controller 102 as the digital signal 130.

Referring to FIG. 1, the gesture recognition device 100 further includes a classification module 131 and an interaction module 133, both operable by the microcontroller 102. The classification module 152 is able to localize the position of the target at a momentary delta time. The microcontroller 102 feeds the digital signal 130 (which represents measured/detected IR light levels from the sensors 118) to the classification module 152 in order to estimate the location of the hand in three dimensional (3D) space. In other words, when a user performs a hand gesture (or movement), the gesture is mapped as thirty consecutive momentary locations of the hand as represented by corresponding digital signals 130 for analysis by the classification module 152. In this embodiment, the classification module 152 is implemented with a Bayes Network algorithm which includes different classifiers for each axis and gesture recognition. For example, the classifiers may be trained to estimate five levels in X-axis, four levels in Y-axis, and two levels in Z-axis.

Specifically, in this embodiment, classification is implemented as a two-stage process. A first stage estimates the hand locations at a momentary time in the x, y and z axes, and second stage determines an exact gesture the user performed based on an array of hand locations.

To elaborate, in the first stage, a location classifier is run on the received digital signal 130 representing the IR light levels of each sensor 118 to define an array of estimated hand locations in the 3D space. The location classifier may be trained for example, using a same lighting pattern (with the same directions and intensities of the illuminations) to direct at a target multiple times but for each time, the direction of the sensors change (so the reflected illuminations are different). Sequential Minimal Optimization (SMO) method is used to partition the training problem into smaller problems that can be solved analytically using heuristics.

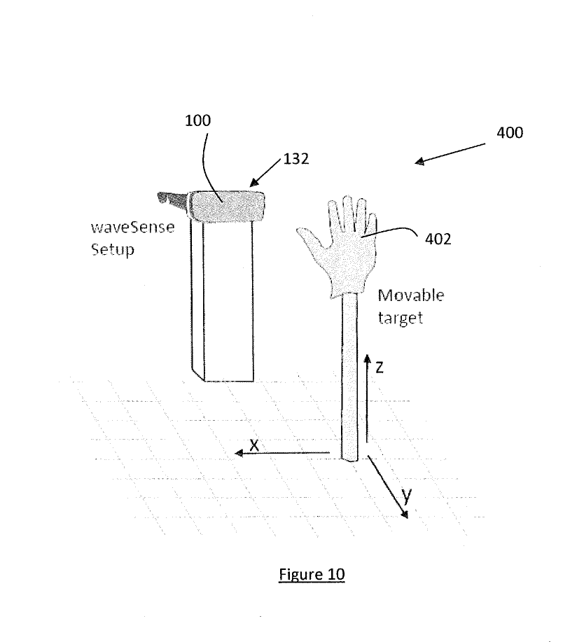

FIG. 10 illustrates a setup 400 for training a classifier such as the location classifier. The setup 400 includes the gesture recognition device 100 configured as an extension to the Gear VR™ headset 132 as illustrated in FIG. 2a and a dummy target 402 movable on a Cartesian marked floor, where the dummy target 402 may be moved along x, y and z axes respectively. Broadly, the training may include placing the dummy target 402 at a first known position, controlling the gesture recognition device 100 to sequentially direct each of a plurality of lighting patterns at the dummy target 402 with each lighting pattern comprising a plurality of illuminations from respective ones of a plurality of emitters 108 in which each lighting pattern differs from other lighting patterns by at least an intensity of one of the illuminations and in which the intensity of the illumination from at least one emitter is variable between more than two levels. The training may further include receiving, at the plurality of sensors 118, reflected illumination of each lighting pattern as reflected from the dummy target 402, moving the dummy target 402 to a subsequent known position and repeating the above steps for a predetermined number of subsequent known positions; and training the location classifier to associate the reflected illuminations to positions of the dummy target 402 using the reflected illuminations and the known positions.

In a specific training session, training data is collected by moving the dummy hand 402 in a 3D grid (13×13×3) and recording 50 samples of sensor data for each location. The sensors 118 of the gesture recognition device were placed at a location (7, 0, 1) of the grid and the physical unit length of the dummy hand on the grid is x=5 cm, y=5 cm, z=10 cm.

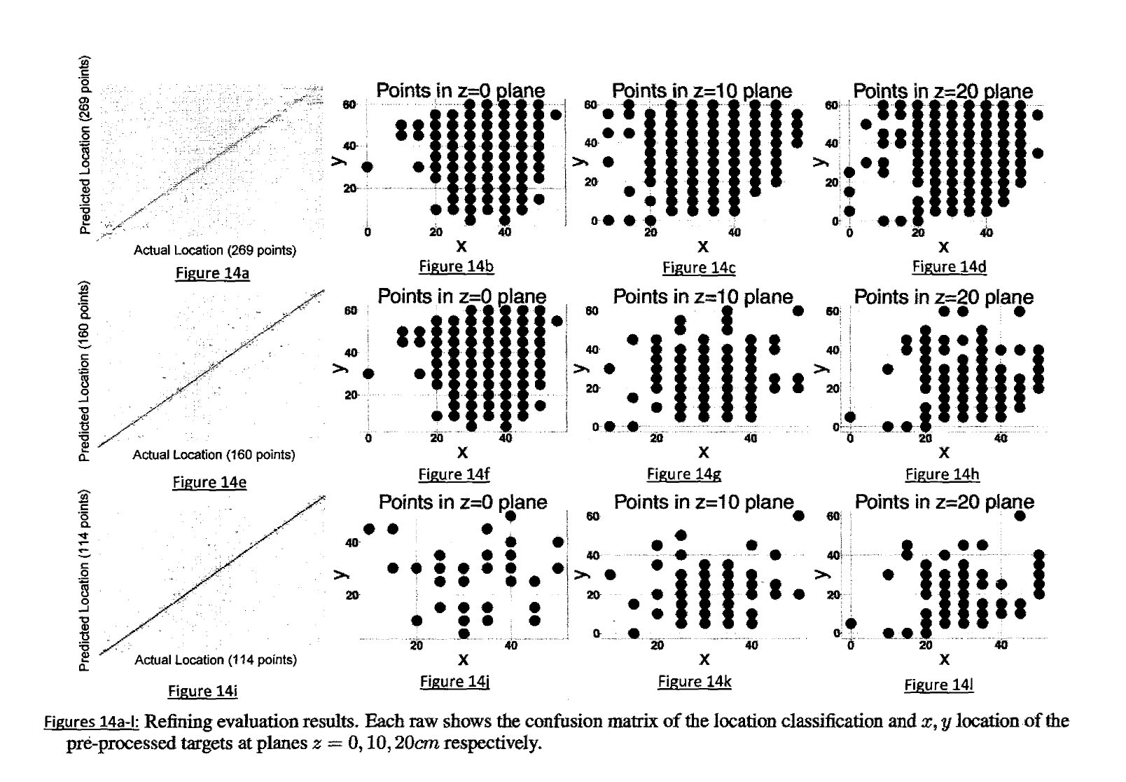

A ten-fold cross validation showed significant confusion between locations as shown in FIG. 14a and relevant data points along the planes z=0, 10, 20 are shown in FIGS. 14b to 14d. This would be expected since the captured data locations used linear displacement while the IR irradiance patterns were non-linear (See FIG. 3). This may lead to high confusion among the locations that lie in the same illumination region. Therefore, an iterative filtering process of the locations was carried out to minimize errors. First, location instances with cross validation less than or equal to 0.30% were removed and in this example, 109 points were removed from the dataset illustrated in FIG. 14a, resulting in a dataset with 160 target locations (shown in FIGS. 14f to 14h). FIG. 14e shows the confusion matrix of the selected 160 target locations.

From the results of FIGS. 14e to 14h, the target locations with at least 80% accuracy were extracted resulting in a final dataset of a total of 114 location points as shown in FIGS. 14j to 14l. FIG. 14i shows the confusion matrix with the final 114 points. Classifier accuracies show that the selected 114 points have a high probability of correct classification, with 86.6% correctly classified instances and a mean absolute error 0.0033.

In the second stage, a gesture classifier (also previously trained like the location classifier) matches the estimated hand locations in the array to a gesture database to determine the performed gestures 154 as illustrated pictorially in FIG. 1. The determined gestures 154 are then provided to the interaction module 156 which provides the inputs to interact with the Samsung™ Gear VR™.

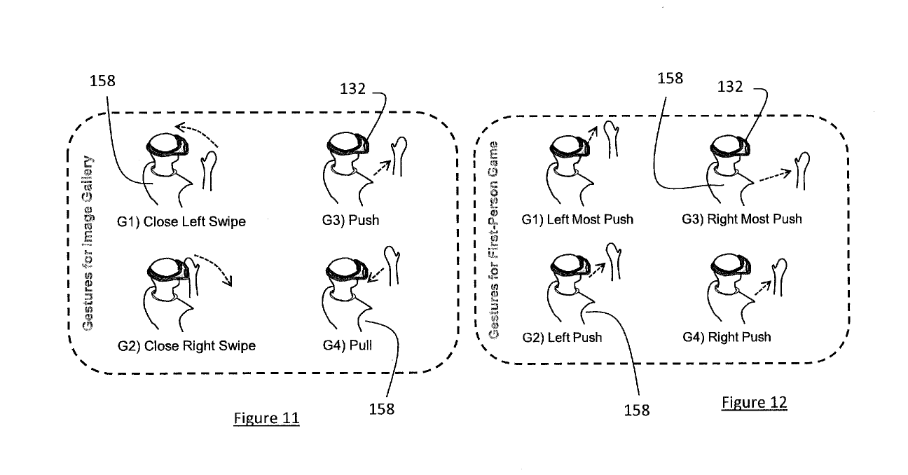

Next, two specific examples of how the gesture recognition device 100 is adapted to determine gestures and for interacting with the Gear VR™ 132 would be described. Specifically, the emitters 108 and sensors 118 of the gesture recognition device 100 are mounted to the front facing surface of the optical lens of the Gear VR™. In a first example, the gesture recognition device 100 is used to detect gestures for interaction with an image gallery. The four exemplary distinct gestures are illustrated in FIG. 11 and they are:
(i) Close-Left-Swipe,
(ii) Close-Right-Swipe,
(iii) Middle-Pull, and
(iv) Middle-Push.

When an image gallery app in the Gear VR headset 132 is run (or via a mobile phone communicatively attached to the headset 132), the image gallery may be viewed by a user 158 wearing the headset 132. The image gallery is intuitive and allows the user 158 to browse, select task and interact with its contents in a virtual reality environment. Specifically, images in the intuitive browsing image gallery are uniformly distributed around the user 158 in 360° all round.

When the user 158 performs a Close-Left-Swipe as shown in FIG. 1, the lighting pattern from the emitters 108 comprising the plurality of illuminations are interrupted by the hand movement and generate different reflected volumetric illuminations at the sensors 118. The volumetric illuminations are then processed by the microcontroller 102 and the classification module 152 to determine the gesture performed, and this determined gesture is then provided to the interaction module 156 which controls the image gallery such that a right image of a user's view gains focus and moves to the center of the user's view accordingly. Likewise, Close-Right-Swipe gesture would control the image gallery to move a left image of the user's view to gain focus and move to the center of the use's view.

In other to select a focused image in the front, the user can perform the Middle-Pull gesture of FIG. 11 which moves the image closer to the user demonstrating the selection. A Middle-Push gesture may be made in front of Gear VR™ for going to back to the default browsing position.

As a result, the gesture recognition device 100 cooperates with the Gear VR™ headset 132 to intuitively browse the Image Gallery using four distinct gestures.

In a second example, the gesture recognition device 100 and the Gear VR™ are used to detect gestures for interaction with a “First-Person Game”. In this game, the user 158 has to destroy incoming armored-tanks exactly at defined mine fields. Tanks come straight towards the user 158 as viewed from the Gear VR™ headset randomly from four directions in a speed that increases over the time. The task given to the user 158 is to destroy the tanks on four minefields before they escape. This application emphasizes the potential of the gesture recognition device 100 in virtual reality context for various gesture interactions.

The task in the game can be completed using four different angled push gestures (see FIG. 12):
(i) Left-Most-Push,
(ii) Left-Push,
(iii) Right-Push; and
(iv) Right-Most-Push.

When the user 158 performs respective gestures depending on the locations of the tank while it's on the on the minefield, the tanks are destroyed. These gestures span from left to right of the user 158 and is similarly sensed by the gesture recognition device 100 and provided to the interaction module 156 for interaction with the game. There are also counters counting the number of tanks destroyed or passed by. The user 158 wins the game when the user 158 destroys a certain number of tanks within sixty seconds whereas the user loses when number of passed tanks reached ten.

In the described embodiment, the gesture recognition device uses an IR based non-focused sensing system which reduces power usage and cost compared to traditional alternatives. In the described embodiment, intensities of each emitter 108 are varied by more than two levels and this increases the range of detection and improves noise immunity. In addition, the gesture recognition device 100 achieves low power, low processing overhead and is a viable solution for resource limited interactive systems. The gesture recognition device 100 may trade off the hand tracking resolution to save power while being able accurately recognize a reasonable number of expressive gestures to interact with intended applications.

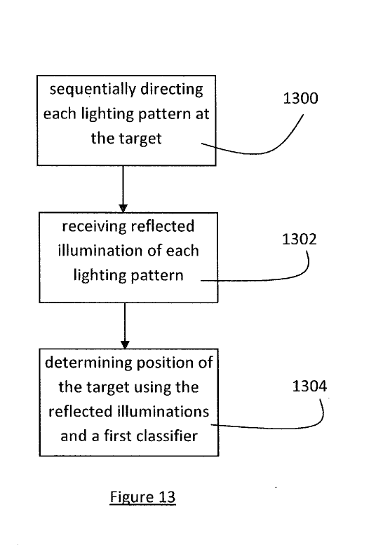

Specifically, the embodiment describes a method and device for determining a position of a target such as a hand and FIG. 13 is a flowchart illustrating an overview of the method. Referring to FIG. 13, the method comprises, at 1300, sequentially directing each of a plurality of lighting patterns at the target, each lighting pattern comprising a plurality of illuminations from respective ones of a plurality of emitters, receiving, at a plurality of sensors, reflected illumination of each lighting pattern as reflected from the target at 1302; and determining, at 1304, the position of the target using the reflected illuminations of the lighting patterns and a first classifier previously trained to associate the reflected illuminations to a position of the target; wherein each lighting pattern differs from other lighting patterns by at least an intensity of one of the illuminations; and wherein the intensity of the illumination from at least one emitter is variable between more than two levels.

The embodiment also describes a method and device for training a classifier for determining a position of a target, the method comprising:

(i) placing the target at a first known position;

(ii) sequentially directing each of a plurality of lighting patterns at the target, each lighting pattern comprising a plurality of illuminations from respective ones of a plurality of emitters, wherein each lighting pattern differs from other lighting patterns by at least an intensity of one of the illuminations and wherein the intensity of the illumination from at least one emitter is variable between more than two levels;

(iii) receiving, at a plurality of sensors, reflected illumination of each lighting pattern as reflected from the target;

(iv) moving the target to a subsequent known position;

(v) repeating (ii)-(iv) for a predetermined number of subsequent known positions; and

(vi) training the classifier to associate the reflected illuminations to positions of the target using the reflected illuminations and the known positions.

To elaborate further, the described embodiment may possess the following advantages:
High spatial efficiency: the gesture recognition device 100 need not have many emitters/sensors and works with a minimal number of sensors/emitters in close spans. As such, sensitive space relative to the space required by the sensors/emitters is larger.
Low processing power: Due to compressive sensing principle and the use of a fewer sensors/emitters, the gesture recognition device 100 requires low signal processing power.
Low energy consumption: the gesture recognition device 100 consumes low energy due to selective region illumination (SVI) and the use of only a minimum number of emitters (eg. two emitters).
Low cost.
The use of selective volumetric illumination (SVI) expands the operational range of the sensing to about 60 cm, further than known systems.

The described embodiment uses selective volumetric illumination to produce different lighting patterns, which is achieved by varying one or more of (1) the intensities of the illuminations, (2) the directions of these illuminations (by varying the directions of the emitters) and (3) the directions of the sensors. In one example, the same lighting pattern (with the same directions and intensities of the illuminations) may be directed at the target multiple times but for each time, the direction of at least one sensor is different (so the reflected illuminations are different and can be used to train the classifier).

In the described embodiment, the intensity of at least one of the illuminations emitted by one of the emitters 108 may be varied by more than two levels. By varying the intensities between more levels, there is a greater variety of lighting patterns directed at the target. In turn, there is a greater variety of reflected illuminations received at the sensors, and this can help make the classifier (trained using the reflected illuminations) more accurate. The range of detection and immunity of noise can hence be increased.

The method of determining a position of a target in the described embodiment may be used for many purposes, other than for gesture recognition. For example, the method may be used for 1) recognizing the pointing and selecting of items in virtual space using hands, 2) identifying objects other than body parts, 3) collision avoidance and 4) activity detection.

The described embodiment is particularly useful for devices with limited power and energy resources such as mobile devices.

The described embodiment should not be construed as limitative. For example, the carrier signal may have a different frequency, instead of 57.6 KHz. The emitters 108 may not generate IR rays but other light may be used. The gesture recognition device 100 may have other components, not the microcontroller 102 may include a processor. The number of emitters 108 and sensors 118 may also be varied depending on application, and similarly ratio of emitters 108 to emitters 118 may similarly be varied too.

Having now fully described the invention, it should be apparent to one of ordinary skill in the art that many modifications can be made hereto without departing from the scope as claimed.

1. A method for determining a position of a target comprising:
sequentially directing each of a plurality of lighting patterns at the target, each lighting pattern comprising a plurality of illuminations from respective ones of a plurality of emitters,
receiving, at a plurality of sensors, reflected illumination of each lighting pattern as reflected from the target; and
determining the position of the target using the reflected illuminations of the lighting patterns and a first classifier previously trained to associate the reflected illuminations to a position of the target;
wherein each lighting pattern differs from other lighting patterns by at least an intensity of one of the illuminations; and
wherein the intensity of the illumination from at least one emitter is variable between more than two levels.

2. A method for training a classifier for determining a position of a target, the method comprising:
(i) placing the target at a first known position;
(ii) sequentially directing each of a plurality of lighting patterns at the target, each lighting pattern comprising a plurality of illuminations from respective ones of a plurality of emitters, wherein each lighting pattern differs from other lighting patterns by at least an intensity of one of the illuminations and wherein the intensity of the illumination from at least one emitter is variable between more than two levels;
(iii) receiving, at a plurality of sensors, reflected illumination of each lighting pattern as reflected from the target;
(iv) moving the target to a subsequent known position;
(v) repeating (ii)-(iv) for a predetermined number of subsequent known positions; and
(vi) training the classifier to associate the reflected illuminations to positions of the target using the reflected illuminations and the known positions.

3. A method according to claim 1, wherein at east two lighting patterns differ by a direction of one of the illuminations.

4. A method according to claim 1, wherein receiving, at a plurality of sensors, reflected illumination of each lighting pattern as reflected from the target comprises:
receiving at a first sensor reflected illumination of a first lighting pattern;
changing a direction of the first sensor; and
receiving at the first sensor reflected illumination of a second lighting pattern.

5. A method according to claim 1, wherein for each lighting pattern, a direction of each illumination is at a non-zero angle with respect to a direction of at least one other illumination.

6. A method according to claim 5, wherein the emitters are arranged in a non-linear configuration.

7. A method according to claim 6, wherein the emitters are arranged along a curve.

8. A method according to claim 6, wherein the emitters are arranged at points lying in a non-linear configuration on a flat surface.

9. A method according to claim 5, wherein the emitters are arranged in a linear configuration and are cooperatively configured to direct the illuminations in particular directions to form each lighting pattern.

10. A method according to claim 1, wherein sequentially directing each of a plurality of lighting patterns at the target comprises providing idle periods of time between consecutive lighting patterns, wherein during each idle period of time, all the emitters are turned off.

11. A method according to claim 1, wherein the position of the target is determined using digital output from the plurality of sensors, the digital output being indicative of the reflected illuminations.

12. (canceled)

13. A method according to claim 1, wherein there are two emitters and six sensors.

14. A device for determining a position of a target comprising:
a plurality of emitters cooperatively configured to sequentially direct each of a plurality of lighting patterns at the target, each lighting pattern comprising a plurality of illuminations from respective ones of the plurality of emitters;
a plurality of sensors configured to receive reflected illumination of each lighting pattern as reflected from the target;
a processor configured to determine the position of the target using the reflected illuminations of the lighting patterns and a first classifier previously trained to associate the reflected illuminations to a position of the target;
wherein each lighting pattern differs from other lighting patterns by at least an intensity of one of the illuminations; and
wherein at least one emitter is configured to provide an illumination with an intensity variable between more than two levels.

15. A device according to claim 14 further comprising a modulator arranged to receive a transmission signal generated by the processor, and to modulate the transmission signal with a carrier signal to generate a modulated signal.

16. A device according to claim 14, further comprising a power level controller arranged to receive the modulated signal and to generate a control signal for operating each emitter at eight different intensity levels for the corresponding lighting pattern.

17. A device according to claim 15, wherein frequency of the carrier signal is 57.6 kHz.

18. A device according to claim 14, further comprising a receiver arranged to receive the reflected illumination of each lighting pattern from the plurality of sensors and for converting the received reflected illumination into a digital signal, and the processor is arranged to determine the position of the target based on the digital signal.

19. A device according to claim 14, further comprising a second classifier previously trained to associate detected positions of the target with a distinct gesture.

20. A device according to claim 19 further comprising an interaction module for interacting with a virtual reality device using the distinct gesture.

21. A device according to claim 14, wherein the device comprises one of a virtual reality device, a mobile device or a device for public use.

22. (canceled)
